(19) United States
(12) Patent Application Publication
(10) Pub. No.: US 2011/0208554 A1
(43) Pub. Date: Aug. 25, 2011

(54) METHOD FOR QUANTIFYING AND COMPARING RECYCLING AND REUSE

(76) Inventors: Albert Matyasovsky, Houtzdale, PA (US); Lloyd Rhoades, Howard, PA (US); Brendan Bagley, State College, PA (US)

(21) Appl. No.: 13/032,880

(22) Filed: Feb. 23, 2011

Related U.S. Application Data
(60) Provisional application No. 61/307,081, filed on Feb. 23, 2010.

(51) Int. Cl. G06Q 10/00; G06Q 90/00

(52) U.S. Cl. 705/7.11; 705/500

(57) ABSTRACT

Embodiments of the invention relate to an index for measurement and comparison of recycling, reuse, and disposal of waste within and among organizations. Some embodiments feature computer display of information regarding recycling, reuse, and disposal. Other embodiments include computer storage media including instructions that, when implemented, allow one to display information regarding recycling, reuse, and disposal.

### CROSS-REFERENCE TO RELATED APPLICATIONS

This application claims priority to U.S. Provisional Patent Application No. 61/307,081, filed on Feb. 23, 2010. That application is incorporated by reference herein.

### BACKGROUND OF THE INVENTION

1. Field of the Invention

Embodiments of the invention relate to indexes and methods of measuring and quantifying progress in zero waste management programs. These include, for example evaluation of response and diversion comparisons of waste stream materials through processes such as: recycling, reuse, composting, waste to energy, return policies, and sanitary drain discharge. Further embodiments relate to novel methods for presenting and sharing these comparisons, as well as to computer storage media including instructions that, when executed, display measurements of the invention.

2. Background of the Art

Having a zero waste management program (i.e. a waste management program where all waste is recycled, reused, composted, waste to energy or otherwise diverted) is a goal of many organizations. Unfortunately, it is challenging to measure progress of a waste management program because comparisons with multiple and varied organizations, or benchmarking within an organization or within subparts of an organization, is difficult, if not impossible. It would be helpful to have a standard method and index for evaluating and comparing multiple and varied types of waste management programs.

### SUMMARY OF THE INVENTION

In embodiments of the measurement index provided herein, the waste stream is considered to be made up of components or categories, the largest divisions that are typically considered are Traditional and Non-traditional components of waste, which may be broken down further into recycle, reuse, compost, waste to energy or other parts and sub-parts. For example, if a facility has a waste process response for 80% of the waste stream and has diverted 51%, then its measurement index for response and diversion is 80/51.

Review of the response/diversion index allows one to move to the essence of any organization's response and diversion program in an instant. By using the measurement index, an organization quickly recognizes, for example, that the waste program is at 80% of development and that it is diverting 51% of this stream. A list of what to measure may accompany the measurement index. Typically, an organization needs to identify all that applies to its waste stream and then check those for which it has a collection or other diversion process in place. This percentage is the response index.

Second, the organization should evaluate recycle, reuse, compost, and waste to energy rate or other diversion alternatives as it applies to all materials in its waste stream. The total diverted divided by total waste provides a diversion index. Together the response and diversion indexes (ReDi Index) provide valuable comparative information. If one were to apply their program to the concept of Zero Waste using the ReDi index, and all waste generated was recycled/re-used as otherwise diverted then an organization's reuse and diversion index would be 100/100.

Embodiments of the invention further describe methods for displaying a response and diversion index on a computer display, as well as computer-readable storage media that embody computer-readable instructions that, when executed, implement a method of displaying a response and diversion index. Additional embodiments may include methods of displaying comparisons of the response and diversion indexes from various organizations that are selected by location, type, or other criteria.

### BRIEF DESCRIPTION OF THE FIGURES

FIG. 1 shows a typical general-purpose computing environment that can be used to perform certain embodiments of this invention. This figure and the related text in the Detailed Description of the Invention, below, are adapted from U.S. Patent Application Publication No. 2010/0332414, to Mead, et al., which was published on Dec. 30, 2010, and is incorporated by reference herein.

FIG. 2 shows a sample entry display for an embodiment of the invention.

FIG. 3 shows the sample entry display of FIG. 2, but with various selections made from some of the drop-down boxes.

FIG. 4 shows a sample index for the data entered in Example 3.

FIG. 5 shows a detailed display of the “green” responses for the Response value of the index of Example 3.

### DETAILED DESCRIPTION OF THE INVENTION

### I. Calculation of Response and Diversion Scores

Embodiments of the invention relate to processes for measuring an organization's management of a waste stream, including providing a set of waste categories, determining how many waste categories within the set are the subject of at least one of recycling, reuse, diversion, compost, waste to energy or other diversion processes by an organization responsible for generating the waste, and calculating a first score. It should be noted that although embodiments of the invention are described in terms of organizations, an individual or household's management of his or her own waste may also occur. Further embodiments of the invention relate to methods for displaying information relating to an organization's waste management on a computer display, as well as to computer-readable storage media that embody computer-readable instructions that, when implemented, display information according to methods of the invention.

In one embodiment a first score and a second score are calculated. Of course, one skilled in the art will recognize that meaningful information would still be provided if the positions of the scores were reversed, and that assignment of terms such as “first score” and “second score” in this disclosure are primarily for the convenience of the reader. Similarly, the term “organization” should be read to include but not be limited to such places as schools, universities, hospitals, offices, retail outlets, and the like.

In one embodiment, a first score, also known as a “response” score shows the number of waste categories subject to at least one of recycle, reuse, compost, and waste to energy or other diversion response processes at an organization, relative to the total number of waste categories for which the organization generates and tracks waste. In another embodiment the response score may be assigned based on the number of waste categories subject to at least one of recycle, reuse, compost, and waste to energy or other diversion response processes at an organization, relative to the total number of waste categories that the organization might be expected to generate; in this way some element of self-reporting could be eliminated.

A second score, also known as a “diversion” score, may then be calculated. This score compares the amount of waste subject to at least one of recycling, reuse, and diversion by the organization with the total amount of waste generated by the organization over a specified unit of time, such as a month or a year. Properties such as the mass or volume of the waste generated by an organization may be measured. For example, if an organization generates 150 tons of waste and recycles, reuses, or diverts 120 tones of the waste, then the diversion score would be 120/150 for that organization. Of course that score could also be expressed as a decimal amount (in this case, as 0.8) or as a percentage (in this case, as 80%). Typically the information is presented as a percentage, where a higher percentage is more favorable.

The response and diversion scores may be displayed as a measurement of the organization's waste management. This allows an organization to quickly determine both how well they are utilizing the broad array of recycling, reuse, and diversion opportunities that are available, as well as to determine the status of their overall recycling, reuse, or diversion amounts.

Typically the first score represents the number of waste categories in which at least one of recycle, reuse, compost, waste to energy or other response diversion processes takes place as a percentage of the total number of waste categories in the set. Typically the second score represents the amount of waste subject to at least one of reuse, recycling, and response as a percentage of total waste. For best results, waste amounts should be verifiable by certified scale weigh slips or formulas. Typically the measurement is presented in the format of “[first score]/[second score].”

For example, an organization with a measurement of 55/43 has processes in place to recycle, reuse, or divert materials at 55% of the total number of waste categories that they generate and track, and of the total waste generated 43% is diverted from the non-sustainable means of disposal. These non-sustainable means of disposal may include, for example, introduction into a landfill. Ideally if an organization participates in recycling, reuse, or other response processes for all of the categories of their waste stream, and that 100% of the available amount of waste is diverted, this would result in a measurement index of 100/100.

### II. Assignment of Additional Identifiers

An organization may be assigned an identifier based on North American Industry Classification System (NAICS), though other classifications may be used if desired. This identifier should represent the facility type for the organization participating in the index. The facility may be compared to similar facility types by size of the waste stream in tons, location, locale, proximity, and commodity type. Organizations may assign separate identifiers for all of their subentities, such as on a per store location or based on business units. For example, a university may be assigned the identifier “61” and this identifier would be placed with the other measurements. In the hypothetical 55/43 measurement above, conversion to 61/55/43 would allow a person reading the data to know immediately that the numbers would relate to universities.

Inclusion of multiple identifiers may allow an organization using the measurement described herein to make comparisons of its reuse, recycling, and diversion processes with that of its peers. For example, identifiers may show that an organization is a public university with a 5000 ton waste stream, located in a suburban locale. The organization would be able to compare its recycling, reuse, and diversion processes with those of similar institutions.

The measurement provided herein may be calculated, stored, arranged, manipulated, compiled, displayed, and/or shared using a network, a computer, or another electronic medium. Particular embodiments provide methods for display of the index on a computer screen. Other embodiments are directed to computer-readable storage media that include computer-readable instructions that when executed implement a method of displaying index information.

### III. Display of Index Information on a Computer and Computer-Readable Storage Media Including Instructions for Implementing A Display

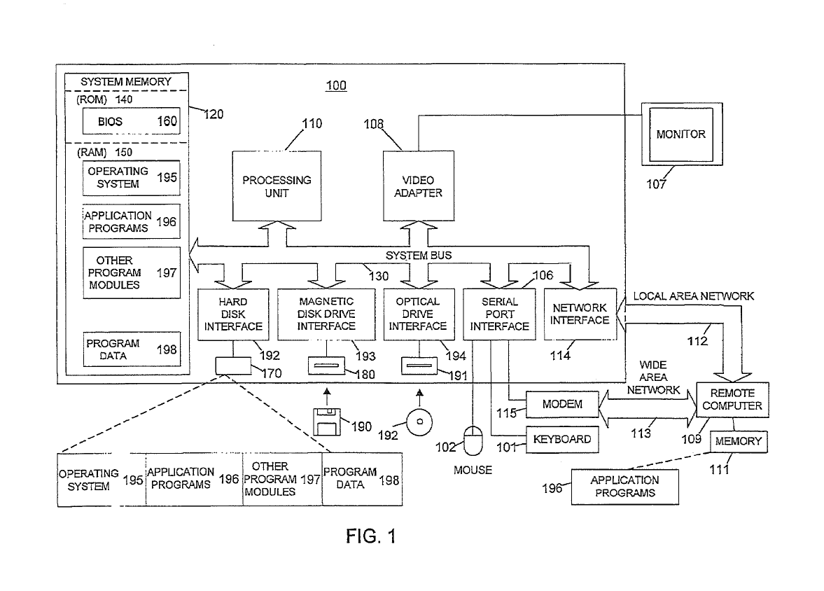

FIG. 1 shows a diagram of a conventional computer that could be used to practice certain embodiments of the invention. FIG. 1 is a schematic diagram of a conventional general-purpose digital computing environment that can be used to implement various embodiments. The description of a general computer in this subsection represents a computer system as is typically known in the art. Of course, nothing shown in this description specifically teaches or suggest creation or display of an index as presented by embodiments of the invention. FIG. 1 and the description of FIG. 1 as presented subsequently in this section are adapted from or copied from their original presentation in U.S. Patent Application Pub. No. 2010/0332414, which is incorporated by reference herein. A computer 100 includes a processing unit 110, a system memory 120, and a system bus 130. The system bus couples system components, including the system memory, to the processing unit 110. The system bus 130 may be any of several types of bus structures. These include, for example, a memory bus or memory controller, a peripheral bus, and a local bus using any of a variety of bus architectures. The system memory includes read only memory (ROM) 140 and random access memory (RAM) 150.

A basic input/output system 160 (BIOS) is stored in ROM 140. The BIOS contains the basic routines that help to transfer information between elements within the computer 100, such as during start-up. Computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively.

The drives and their associated computer-readable media provide nonvolatile storage of computer readable instructions, data structures, program modules and other data for the personal computer 100. Of course, a single computer may not have all of these types of memory, and it will be appreciated by those skilled in the art that other types of computer readable media which can store data that is accessible by a computer may be used. These include, for example, but are not limited to magnetic cassettes, flash memory cards, digital video disks, Bernoulli cartridges, random access memories (RAMs), read only memories (ROMs), and the like.

Program modules can be stored on the hard disk, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Input devices are often connected to the processing unit 110 through a serial port interface 106 that is coupled to the system bus, but may be connected by other interfaces, such as a parallel port, game port or a universal serial bus (USB). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment. The environment may use logical connections to one or more remote computers, such as a remote computer 109. Remote computer 109 can be a server, a router, a network PC, a peer device or other common network node, and typically includes many or all of the elements described above relative to computer 100, although only a memory storage device 111 has been illustrated in FIG. 1. The logical connections depicted in FIG. 1 include a local area network (LAN) 112 and a wide area network (WAN) 113.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

### IV. Achievement Awards and Additional Advantages

The measurement index provided herein may also be useful for establishing achievement ratings for organizations participating in measurement. This would be accomplished by setting minimum values for one or more of the numbers in the measurement index, where one or both of the minimum values must be exceeded for the achievement rating to be granted. For example, minimum numbers for bronze, silver, gold, and platinum levels of achievement may be assigned. If these numbers are achieved an organization may have the option to print or order a certificate or other item memorializing their accomplishment, or the certificate or other item may be generated automatically.

In one embodiment of the invention, measurements for multiple organizations are maintained in a central database. The information provided by the organizations should be supported by weigh slips or formulae to ensure the integrity and accuracy of the data. This central database could offer a number of advantages, including the availability of annual or lifetime subscriptions, web-based access to data, an easy-access reference number, inclusion in and comparison to a larger database, calculation and comparison of carbon footprint data. The index may have the unique ability to fairly compare programs using multiple factors for the awarding of grant dollars and recognition of best programs nationally and internationally. In certain embodiments of the invention the data from a plurality of organizations may be collected and displayed on a computer display in a sortable format.

Embodiments of the invention may offer several advantages. First and foremost the index will be a standard by which entities can compare themselves, with the aim of achieving “Zero Waste.” Second, the index will allow a company to readily compare itself to other companies by type, size of waste stream, location, locale, items in the waste stream, etc. In addition, by review of their score in the index with the scores of similarly-sized and/or similarly-situated entities, an organization that uses the index may reach out to other companies who have similar waste streams to discuss best practices that will allow them to improve their own diversion efforts. Information contained in the index will allow companies to compare/contrast themselves with other companies both nationally and internationally in an effort to promote collaboration and improve each company's diversion efforts.

In a further embodiment of the invention, an organization may maintain multiple accounts or a single account that allows insertion of data for multiple sub-parts of an organization. For example, a state university system may include all of its campuses, or a franchisor may require participation by its franchisees. Each franchisee could be required to maintain a minimum score, or to maintain a particular level relative to other franchisees of their size and/or location. Franchisees could be provided with incentives to reach certain numbers, or to place at a certain level among their peer entities. These subscores could be included in the larger expanded index, or they could be excluded from it with an opt-in, opt-out option. This option could be provided to singular entities as well.

### EXAMPLES

### Example 1

Example 1 provides examples of an expanded response and diversion Index that includes evaluations of Type/Scope/Scale/Response/Diversion.

In this example, the first measurement, Response, is determined by calculating the number of waste types that are reused, diverted, or recycled from the following list:

### Master List (ML)—

### Traditional—

Plastic bottles #1
Plastic bottles #2
Plastic bottles #3
Plastic bottles #4
Plastic bottles #5
Plastic bottles #6
Plastic bottles #7
Glass—amber
Glass—clear
Glass—green

### Cans—Aluminum

### Cans—Bi-metal

### Cans—Steel

### Newspaper

### Mixed Office Paper

Press board

### Cardboard

### Non-Traditional—

### Composting—

Food waste (pre-consumer)
Food waste (post-consumer)
Organics (plant material, leaves, trees. brush)
Dead animals
Bio-degradable dinnerware and cutlery
Food soiled paper

### Plastic Film #4

Plastic film #2
Textiles—carpet
Textiles—clothing
Polypropylene (film, utensils and dinnerware)
Styrofoam—pending
Grease trap waste

### Batteries—Ni-Cad

### Batteries—Lithium

### Batteries—Alkaline

Batteries—Lead acid
Florescent light tubes
Compact florescent
Sodium lamps
Metal halide
Scrap metal—ferrous
Scrap metal—non ferrous
Toner cartridges

### Pallets

Kiln dried lumber

### Mattresses

### E-Cycling

Privately owned computers
University owned cell phones
Privately owned cell phones
University owned TV's
Privately owned TV's
University owned Radios
Privately owned Radios
University owned Appliances
Privately owned Appliances

### Residual Waste—

### Asphalt

### Concrete

### Bottom ash

### Fly ash

Used motor oil
Oil filter canisters
Parts cleaner

### Anti-freeze

Used Vegetable oil (bio diesel and bio-hydraulic)
C&D materials

### Dirt

### Reuse—

### Furniture

### Textiles

HVAC equipment
Research/lab equipment
House hold discards
Cardboard boxes

### Rental Services—

Contractor demolition—new construction, remodeling
New furniture installation packaging
Blue pallets
Caterer food waste and recyclables
Other (User may add materials not listed)

Because this list includes 42 items, an entity that recycles, reuses, or diverts 37 of them would have a measurement of 88%. (37/42) Type and scope of the entity may be selected from the following lists:

### Facility Type—

### 11—Agriculture

### 21—Mining

### 22—Utilities

### 23—Construction

### 31—Manufacturing

42—Retail trade

### 51—Information

### 52—Finance

### 53—Real Estate

### 54—Technical Services

### 55—Management Companies

### 56—Waste Management Support

### 61—Educational Services

### 62—Health Care

### 71—Arts and Entertainment

### 72—Repair Maintenance

### 811—Personal Laundry Service

### 813—Religious, Civic Professional Organizations

### 814—Private Households

### 92—Public Administration

Scope (in tons)—
a—1-500
b—501-1000
c—1001-1500d-1501-2000
e—2001-2500
f—2501-3000
g—3001-3500
h—3501-4000
i—4001-4500
j—4501-5000
k—5000-10,000
l—10,000-15,000
m—15,001-20,000
n—20,001-30,000
o—30,001-40,000
p—40,001-50,000
q—50,001-60,000
r—60,001-70,000
s—70,001-80,000
t—????

Similarly, scale, response, and diversion may also be included as values in the measurement.

### Scale (Facility Master List) or (Your Master List)—

Number of commodities from the Master List (ML) in the organization's stream

### Response—

Percent of processes in place, designed to divert commodities, from an organization's Facility Master List (FML).

### Diversion—

Percent diverted from the FML stream.

### Potential—

Waste Audit determination of the percent of the MSW stream that is currently recyclable/re-usable, waste to energy, compost, sanitary drain, return policy potential or other beneficial use is driven by business plan, budget, and market and is relative to the FML.

### Example 2

An airport generates 3500 tons of waste material and is located in an urban center. It has processes in place to respond to 80% of its waste stream: cans, cardboard, scrap metal, used motor oil, and plastic film. The cans, cardboard and scrap metal are recycled. The oil is burned to heat the facility (waste to energy). The plastic film is land filled. However, in this example the airport is unable to get the public to participate, so the program suffers. Of the 3500 tons, only 850 tons, or 24% is diverted. Their index is 80/24.

Basic Expanded

80/24 61/g/u/5/80/24/3/1/1/Jane Doe/Jane@ [email address]/Pittsburgh, Pa./A&B

Aviation

Basic Index

80—Percent with Diversion processes in place (response)

24—Percent of materials Diverted from the landfill (discussion)

Expanded Index

61—Type of Facility

g—Tons of waste generated annually

u—Locale Urban

5—Number of component parts in waste stream

3—Number of component parts Recycled

1—Number of component parts Waste to Energy

1—Number of component parts Land fill

Jane Doe—Contact person (person responsible for waste management)

Jane@[email address]—Jane Doe's email address

Pittsburgh, Pa.—Location

A&B Aviation—Name of Company/Agency/Entity

### Example 3

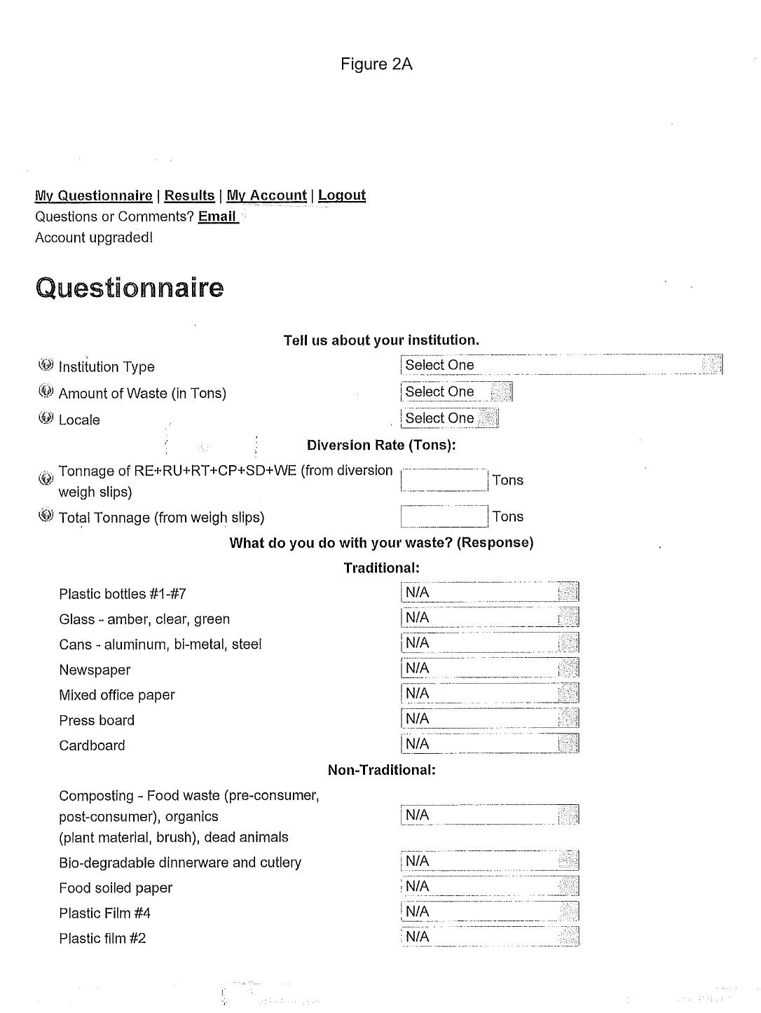

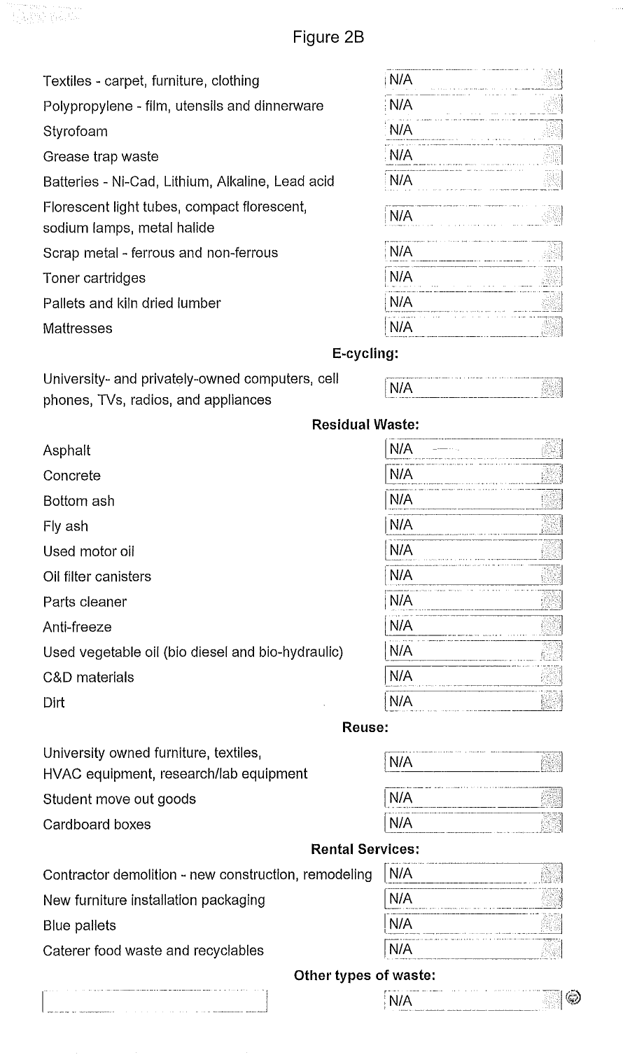

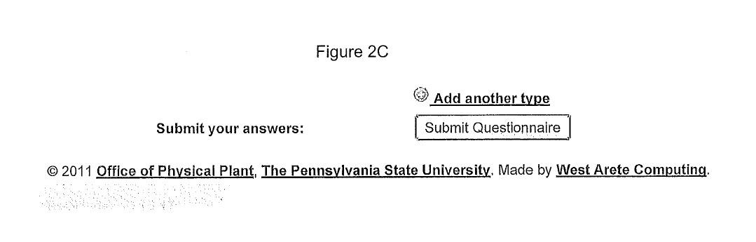

A further example is shown by reference to the Figures. In this example, the representative of an organization access a website that displays various options for input of data used for calculation and display of the response and diversion index. A questionnaire that solicits the data on a computer display screen is shown in FIG. 2. As shown in the figure, the user is solicited to select from a drop-down menu (not shown) an organization (or institution type, range for amount of waste, and locale of the organization. Although not shown, the options for institution type are the same as those in Example 1.

The user is then solicited to input the total tonnage of waste that is recycled, reused, returned, composted, dumped into a sanitary drain, or converted into energy. These types of non-landfill means of disposal may be referred to as “green” disposal methods. As will later be seen, these waste types are considered to have been disposed of in a “green” fashion, which raises the “response” score for the organization. The user is also solicited to include the total tonnage of waste that is disposed of, whether in a green fashion or not. The question marks to the left of each entry may include “tool tips” that display valuable information when a mouse is held over them.

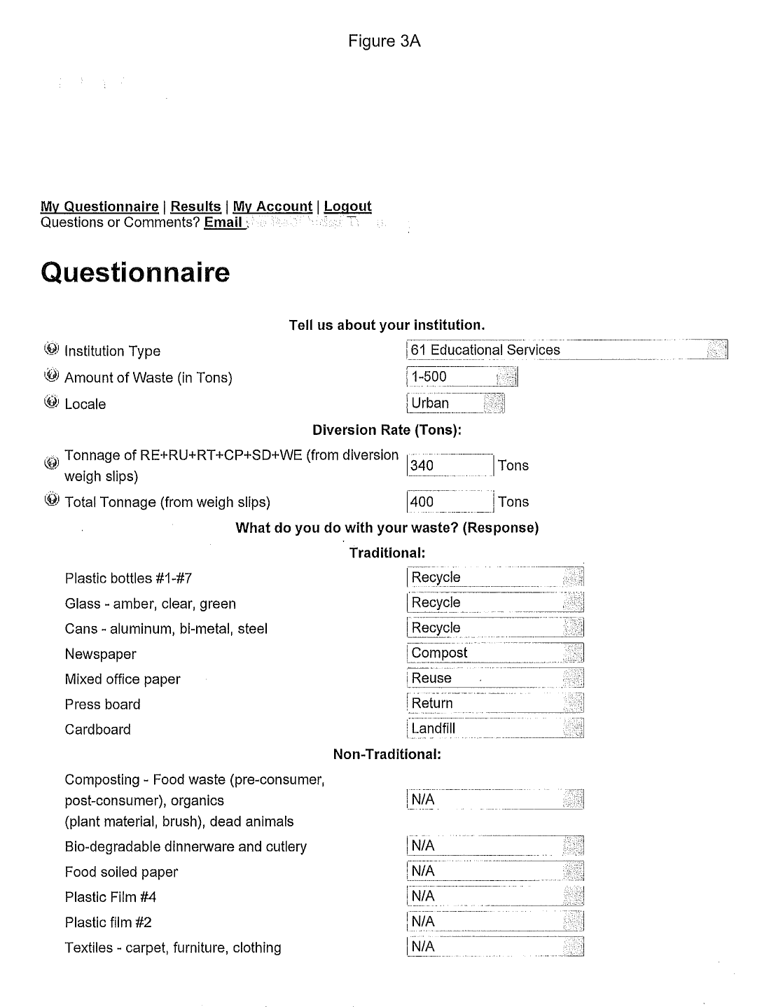

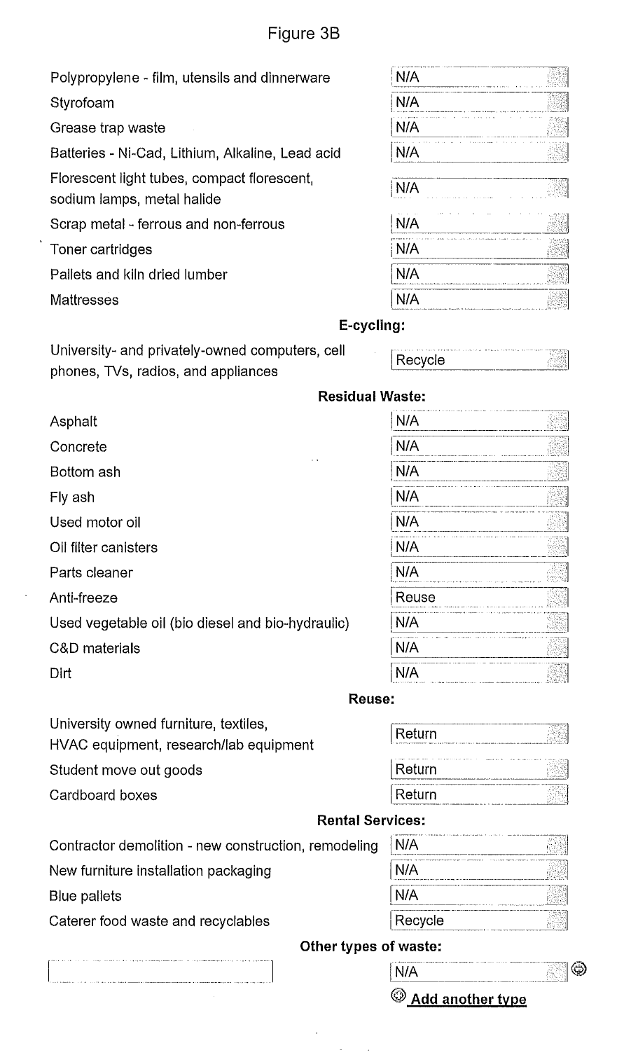

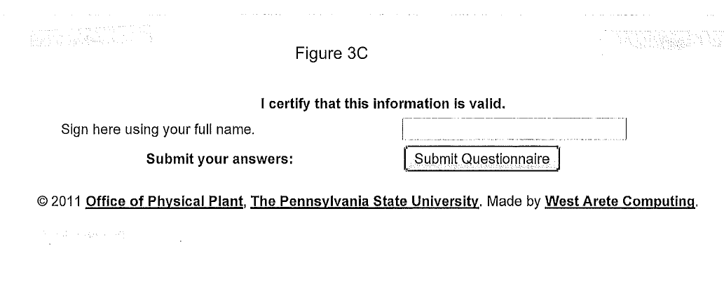

After entering data for as many categories as he wishes (or for as many categories as he has information), the user certifies the result and uploads the information to a remote database. A sample of a completed form is shown in FIG. 3. That figure shows that the user for the Sample Organization chose “Educational Services” as the institution type, “1-500” tons as the amount of waste, and “Urban” as the locale. Total tonnage of waste was entered as 400 tons, while the recycled, reused, returned, composted, sanitarily drained, and waste to energy tonnage was 340 tons. Various options for recycling, reuse, composting, return, and landfill were selected for the traditional waste that is listed. Although disposal types were not selected for other types of waste in this hypothetical example, they could have been.

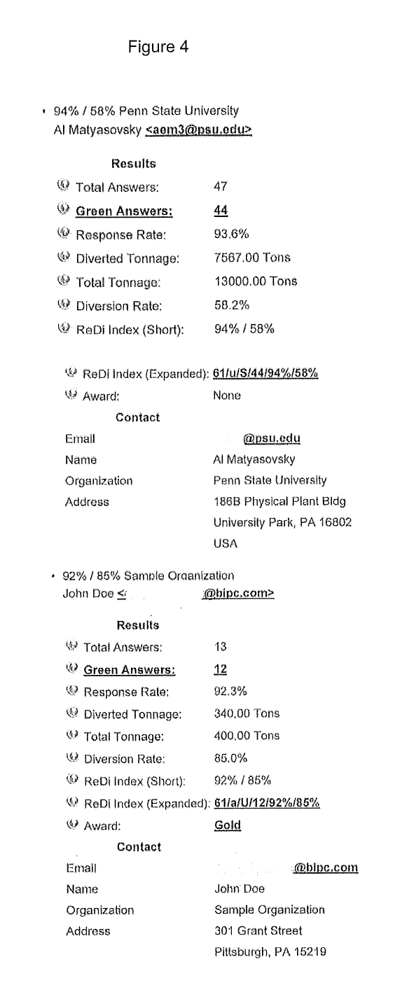

After the information has been entered, the computer system calculates and displays the response and diversion index for the sample organization. The results are shown in FIG. 4 (with a fictional example for another entity). Here, the response rate is 92.3%, reflecting that 13 total waste streams were identified, with 12 of those waste streams disposed of in a “green” fashion. The diversion rate is 85%, which is 340 tons/400 total tons. The index (described as REDI INDEX™) is therefore 92/85. This may be expanded to show that the Sample Organization is an educational institution (61) with low total tonnage (a) in an urban location (U) with 12 waste streams that are disposed of in a “green” fashion. This leads to the stated Expanded REDI INDEX™ value of 61/a/U/12/92%/85%. Thy hypothetical sample organization's index values qualify it for a “Gold” award level, which may then be retrieved and printed.

The information entered in the questionnaire is now displayed in a way that allows quick comparison and analysis with other entities. If desired, the user may select one or more other organizations to make a more detailed review of their response and diversion ratios, as well as a review of contact information for responsible parties at that institution.

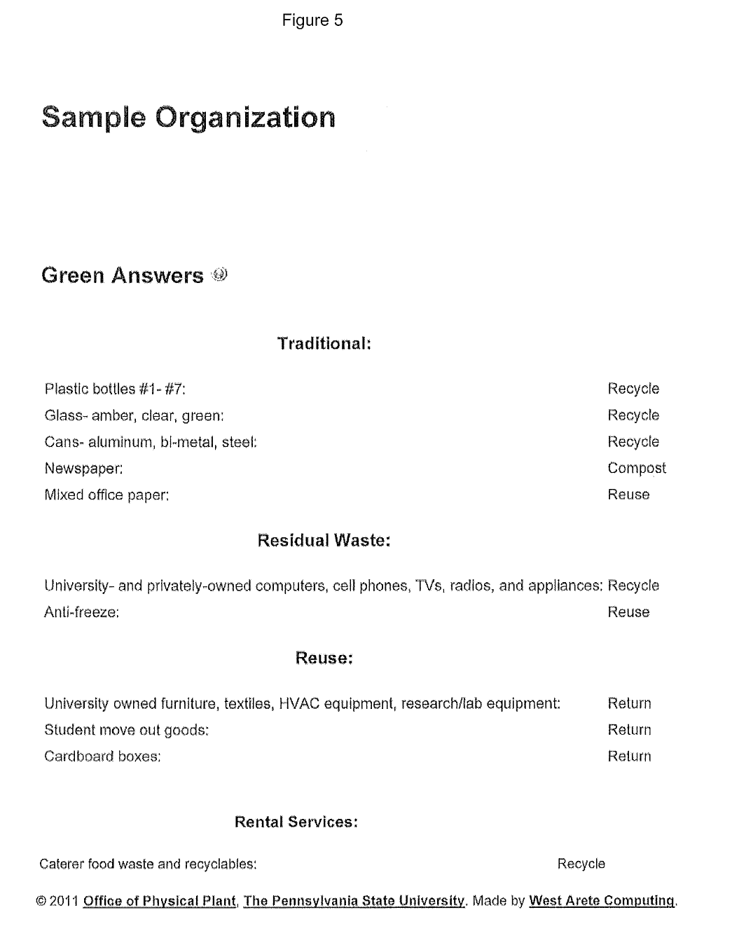

The user may also sort data to review only those organizations that, for example, are similar entity types, have similar tonnages of waste, or are in similar locales. Results may also be sorted by distance from the responding organization. Of course, other filters could be included as desired. Further information may be gained, for example, by review of FIG. 5, which is an indication of all of the “green” (non-landfill) answers made by the Sample Organization.

I claim:

1. A computer-implemented method for displaying on a computer display a measurement of an organization's management of a waste stream, comprising:
(a) displaying on a computer display a list of waste categories;
(b) soliciting from an organization, via the computer display, data regarding the number of waste categories within the list that are generated and tracked by the organization;
(c) soliciting from the organization, via the computer display, the number of waste categories within the list that are subject to at least one of recycling, reuse, diversion, sanitary drainage, return, composting, and waste-to-energy by the organization;
(d) displaying on the computer display a response value evaluating the number of waste categories;
(e) soliciting from the organization, via the computer display, data regarding a total amount of waste generated and tracked by the organization;
(f) soliciting from the organization, via the computer display, data regarding an amount of waste that is disposed of by means other than a landfill; and
(g) displaying on the computer display a diversion value that compares the amount of waste that is disposed of by means other than a landfill to the total amount of waste generated and tracked by the organization.

2. The method of claim 1, wherein the response value is displayed as a percentage.

3. The method of claim 1, wherein the diversion value is displayed as a percentage.

4. The method of claim 1, wherein the measurement is displayed in the format of “[response value]/[diversion value].”

5. The method of claim 1, wherein the amounts of waste are measured by a member of the group consisting of tonnage per year, tonnage per day, and tonnage per month.

6. The method of claim 1, further comprising the steps of displaying an identifier based on industry characteristics of the organization.

7. The method of claim 6, wherein said characteristic is selected from the group consisting of locale, size, industry type, location, and size of waste stream of said organization.

8. The method of claim 1, further comprising preparing a certificate stating the results of the measurement.

9. A computer-implemented method for displaying a comparison of a first organization's management of a waste stream with at least a second organization's management of a waste stream, comprising:
(a) displaying on a computer display a list of waste categories;
(b) soliciting from a first organization, via the computer display, data regarding the number of waste categories within the list that are generated and tracked by the first organization;
(c) soliciting from the first organization, via the computer display, the number of waste categories within the list that are subject to at least one of recycling, reuse, diversion, sanitary drainage, return, composting, and waste-to-energy by the organization;
(d) displaying on the computer display a first response value evaluating the number of waste categories;
(e) soliciting from the first organization, via the computer display, data regarding a total amount of waste generated and tracked by the first organization;
(f) soliciting from the first organization, via the computer display, data regarding an amount of waste that is disposed of by means other than a landfill; and
(g) displaying on the computer display a first diversion value that compares the amount of waste that is disposed of by means other than a landfill to the total amount of waste generated and tracked by the organization; and
(h) displaying on the computer display at least a second response value and at least a second diversion value based on waste disposal data collected from at least a second organization

10. A response and diversion index comprising:
(a) a first score, wherein said first score shows a number of waste categories subject to said at least one of recycling, reuse, and diversion by an organization relative to the total number of waste categories that could be recycled, reused, or diverted by the organization; and
(b) a second score, wherein said second score is a comparison of the tonnage of waste subject to at least one of recycling, reuse, or other diversion processes by said organization compared to the total tonnage of waste generated by the organization.

11. The index of claim 10, further comprising at least one identifier based on at least one characteristic of the organization, wherein said at least one identifier is presented with said first score and said second score.

12. The index of claim 11, wherein said characteristic is selected from the group consisting of locale, size, industry type, location, size of waste stream of said organization.

13. The index of claim 10, wherein said index is expandable, and wherein said expandable index comprises data in addition to the response value and diversion value.

14. One or more computer-readable storage media embodying computer-readable instructions that, when executed, implement a method of displaying a measurement of an organization's management of a waste stream, comprising:
(a) displaying on a computer display a list of waste categories;
(b) soliciting from an organization, via the computer display, data regarding the number of waste categories within the list that are generated and tracked by the organization;
(c) soliciting from the organization, via the computer display, the number of waste categories within the list that are subject to at least one of recycling, reuse, diversion, sanitary drainage, return, composting, and waste-to-energy by the organization;
(d) displaying on the computer display a response value evaluating the number of waste categories;
(e) soliciting from the organization, via the computer display, data regarding a total amount of waste generated and tracked by the organization;
(f) soliciting from the organization, via the computer display, data regarding an amount of waste that is disposed of by means other than a landfill; and
(g) displaying on the computer display a diversion value that compares the amount of waste that is disposed of by means other than a landfill to the total amount of waste generated and tracked by the organization.

15. The one or more computer-readable storage media of claim 14, wherein the response value is displayed as a percentage.

16. The one or more computer-readable storage media of claim 14, wherein the diversion value is displayed as a percentage.

17. The one or more computer-readable storage media of claim 14, wherein the measurement is displayed in the format of “[response value]/[diversion value].”

18. The one or more computer-readable storage media of claim 14, wherein the amounts of waste are measured by a member of the group consisting of tonnage per year, tonnage per day, and tonnage per month.

19. The one or more computer-readable storage media of claim 14, further comprising the steps of displaying an identifier based on industry characteristics of the organization.

20. The one or more computer-readable storage media of claim 19, wherein said characteristic is selected from the group consisting of locale, size, industry type, location, and size of waste stream of said organization.
